(19) United States
(12) Patent Application Publication
(10) Pub. No.: US 2017/0032104 A1
(43) Pub. Date: Feb. 2, 2017

(54) MEDICAL SOFTWARE PLATFORM

(71) Applicant: VICTAIRE INC., Wilmington, DE (US)

(72) Inventors: Robert Cowan, Redwood City, CA (US); Alan Rapoport, Woodside, CA (US)

(21) Appl. No.: 15/082,831

(22) Filed: Mar. 28, 2016

Related U.S. Application Data
(63) Continuation-in-part of application No. 14/016,489, filed on Sep. 3, 2013, now abandoned.
(60) Provisional application No. 62/138,811, filed on Mar. 26, 2015.
(60) Provisional application No. 61/696,153, filed on Sep. 1, 2012.

(51) Int. Cl. G06F 19/00

(52) U.S. Cl. CPC G06F 19/3487; G06F 19/345; G06F 19/3418; G06F 19/363

(57) ABSTRACT

A medical system is disclosed for retrieving and recording information from a patient and generating an efficient and effective clinical report encompassing the relevant data for a practitioner's review. The system may also include one or more communication paths for receiving additional information such as from patient wearables, environmental sensors, medication dispensers, whether sources, allergy sources, and other geographic relevant environmental conditions, contaminants, conditions, traffic congestion, etc.

### PRIORITY

The instant application claims priority as a non-provisional of U.S. Patent Application No. 62/138,811, filed Mar. 26, 2015, and as a continuation in part of U.S. patent application Ser. No. 14/016,489, filed Sep. 3, 2013, which claims priority to U.S. Patent Application No. 61/696,153, filed Sep. 1, 2012, all of which are incorporated by reference in its entirety herein.

### DESCRIPTION OF FIGURES

FIG. 1 illustrates an exemplary system diagram according to embodiments described herein.

### DETAILED DESCRIPTION

Embodiments described herein include a platform that can convert a questionnaire into a narrative report. This technology begins with a patient symptom or complaint such as headache, poor or non-restrative sleep, depression, anxiety etc., and then through a complex programming that employs decision-tree analysis, artificial intelligence expertise, machine learning and a rule-based engine, as well as other sophisticated tools, generates a narrative report as would be generated through an interview with an expert physician specialist in that area of medicine.

A platform that can apply a rule-based engine to a data set to arrive at a diagnosis. Within all areas of medicine, there are diagnostic criteria for medical conditions that match with historical elements, testing results, and physical examination and can lead to a differential diagnosis. This IP is able to extract elements provided in a structured, computer-generated data-base and correlate those elements with criteria delineated in a defined diagnostic category to generate a diagnosis (or set of diagnoses) that fit those historical elements.

The platform may import a writable version of a report into an electronic medical record. In order to integrate electronically-generated narrative reports, data sets, and clinical impressions, this IP is able to import both data elements or narrative components into established electronic medical record fields. For those doctors who are not yet using EMR, they can copy or print the narrative and add to their paper file.

The platform can also search specific data elements within the narrative report or questionnaire and amalgamate that data set from multiple questionnaires to generate reports regarding demographics, trending, clustering and other statistically significant data sets.

The platform may also interact with a mobile app, linking historical data with current data on how the patient feels, what their physiological state is and the status of big data like weather and pollen count and traffic patterns in the patient's vicinity. The system may be able to join the data set and machine learning from a computer-generated report which represents a ‘snapshot’ with ongoing data collection from a mobile app such that historical elements combine with active data to monitor and modify behavior in the user, based on that integration.

The system may also include a mobile app that can collect personal data, monitored data, and data from internet sources and integrate all or a portion into a reportable format in order to incorporate data obtained from the patient with environmental and “wearable” data. This system may provide a program that will integrate information from disparate sources and identify relationships between data sets obtained from these sources.

The platform may convert data from an app into a predictive model for sentinel events. With data sets developed in real time and combined with data sets collected over time, the system may use predictive modeling to identify behaviors which, if implemented or avoided are likely to modify outcomes.

The platform may create push notifications to users based on predictive modeling. This system creates a set of rules which, when met, can provide notification to the user that a specific change in behavior (eg: compliance with medication or meditation, avoidance of high-risk activities, etc.) has a high probability of resulting in a beneficial change in outcome.

The platform may enable an end user to view both the narrative report and a summary of monitored behaviors and outcomes from the app in real time to assess the efficacy of interventions on management of conditions identified in the narrative and the results of push notifications on behavioral changes.

The platform may facilitate creation of questionnaires, narratives, and apps for circumstances in which a questionnaire can be generated based on an initial observation, tied to a rule-based engine, generate a report and a monitoring tool to modify outcomes.

The platform may enable a patient with any medical condition to interact with an expert questionnaire resulting in an algorithm generated analysis in any form which can be beneficial to patient and physician alike.

The platform and system described herein may include any combination of features, applications, or components as described herein. Systems may be duplicated, integrated, added or removed to form exemplary platforms within the scope of the present disclosure.

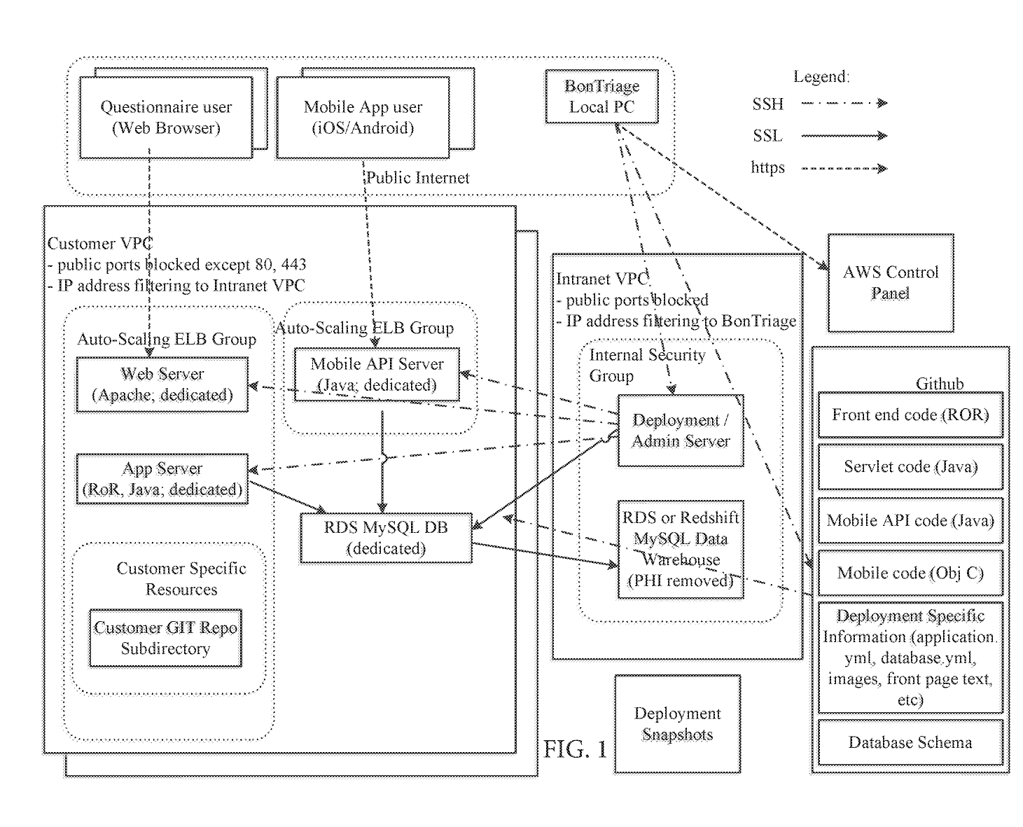

FIG. 1 illustrates an exemplary system diagram to support and implement embodiments described herein. An exemplary system is comprised of hardware and software that helps patients understand more about their headaches and helps physicians do a deeper dive into the history and more easily arrive at the diagnosis and optimal treatment of a headache patient. The system collects historical information via a rule engine and creates a narrative report containing a detailed and complete headache history, including sleep, social, psychiatric and menstrual information; previous and current medications and their side effects and efficacy; prior testing; and comorbidities. It arrives at a clinical impression via the rule engine based on elements that correlate answers from the patient with accepted International Headache Society diagnostic criteria for primary headache diagnoses.

The system integrates this historical data with patient-reported information (such as perceived headache triggers, headache frequency, duration, severity, nausea, vomiting, autonomic changes, medication compliance, acute treatments, etc), geographically specific ambient and publicly available data (such as changes in barometric pressure, pollen counts, traffic patterns, local temperature, etc.) and physiological data obtained from wearable sensors (such as heart rate variability, galvanic skin response, skin temperature, sleep quality and duration, exercise, etc.) These three data sets are used to identify associations between triggers and headaches and to predict for patients when they are at higher risk for headache. It informs patients and their healthcare providers of clinically significant patterns including management of modifiable risk factors and comparative headache diaries on a daily, weekly, and monthly basis through customizable analytics. Patients and physicians use the analysis provided by the system to decide maintain or change therapies based on accurate data at each visit.

The system collects historical and longitudinal data through voice recognition, patient-entered information, and automatic ambient and sensor collection.

The system can also communicate with appropriate wearable devices to deliver medication on a schedule or on-demand through notifications to and subsequent direction from the patient. For example, the patient can trigger administration of medication from a wearable device such as a skin patch. CLAIM

1. A medical system that helps patients provide and receive information about headaches, comprising:
a rules engine for receiving information from a user;
a narrative report engine for receiving the information from the rules engine and generating a narrative report of select information from the received information;
a clinical impression engine that correlates answers from the patient with accepted International Headache Society diagnostic criteria for primary headache diagnoses;
a communication link for receiving personal information about the patient from one or more wearable sensor;
an environmental portal for receiving environmental information from one or more sensors or data sources.
